(19) United States
(12) Patent Application Publication
(10) Pub. No.: US 2023/0337663 A1
(43) Pub. Date: Oct. 26, 2023

(54) AGRICULTURAL COMPOSITION

(71) Applicant: REVOLUTION BIOTECH LLC, Oklahoma City, OK (US)

(72) Inventor: Ryan C. Early, Choctaw, OK (US)

(21) Appl. No.: 17/915,954

(22) PCT Filed: Apr. 1, 2021
(86) PCT No.: PCT/US2021/025350

§ 371 Date: Sep. 29, 2022

Related U.S. Application Data
(60) Provisional application No. 63/005,138, filed on Apr. 3, 2020.
(60) Provisional application No. 63/043,633, filed on Jun. 24, 2020.

(51) Int. Cl. A01N 27/00; A01N 25/30; A01P 3/00; A01P 7/04

(52) U.S. Cl. CPC A01N 27/00; A01N 25/30; A01P 3/00; A01P 7/04

(57) ABSTRACT

An agricultural composition comprising farnesene is provided for controlling plant pathogens. Particularly, the agricultural composition is used to control powdery mildew and other fungi and bacteria.

### FIELD

An agricultural composition comprising farnesene is provided for controlling plant pathogens. Particularly, the agricultural composition is used to control powdery mildew and other fungi, as well as certain insects.

### BACKGROUND

Plant crops are susceptible to disease causing pathogens, which when left uncontrolled may destroy crops, Pathogens typically include, but are not limited to, fungi, such as powdery mildew. Pathogens often proliferate due to agricultural practices and/or environmental factors, e.g., high temperature and humidity. Providing effective control of pathogens in home or commercial agricultural operations is desirable to ensure productivity.

Effective control of pathogens in an environmentally acceptable manner is also desirable. Environmentally friendly agricultural compositions that may control and/or treat and/or reduce and/or remove pathogen populations from plant crops and animals are desirable amongst consumers, who seek out foods that have been grown, cultivated or produced in an environmentally friendly manner, typically utilizing organic and/or biodegradable and/or human and animal safe products.

There remains a need to provide for new and improved agricultural compositions to control pathogen populations, and to control and/or treat disease caused by pathogens.

### SUMMARY

An agricultural composition is provided comprising at least one sesquiterpene.

The sesquiterpene can be farnesene, e.g., β-farnesene.

The farnesene can act as a fungicide, bactericide, insecticide, pesticide or a combination thereof. The farnesene may be a fungicide, e.g., that is effective against powdery white mildew. The farnesene can be a pesticide, e.g., that is effective against flies, aphids, mosquitos, and ants.

The composition may further include a detergent or surfactant, e.g.; an anionic surfactant, a cationic surfactant, and/or a nonionic surfactant.

The agricultural composition may be provided as a concentrate. The farnesene and a carrier, e.g., an oil, can be provided in concentrated form and diluted, e.g., with water, to provide the agricultural composition for application to plants.

It is to be understood that other dilution chemistries may also be employed as an alternative, or in addition to, utilizing water. For example, possible diluents may be, but are not limited to, at least one of glycols, methanol, ethanol, monoethylene glycol, and propylene glycol, or the like.

The farnesene compositions can advantageously contain surfactants. For example, anionic surfactants include (C₆-C₁₈) alkyl benzene sulfonic acid salts, calcium dodecylbenzene sulfonate, sodium dodecylbenzene sulfonate, triethanolamine dodecyl benzene sulfonate, (C₆-C₁₈) alkyl ether sulfates, (C₆-C₁₈) alkyl ethoxylated ether sulfates, sodium lauryl polyoxyethylene ether sulfate, (C₆-C₁₈) alkyl sulfates, (C₆-C₁₈) alkyl phosphate esters, (C₆-C₁₈) alkoxylated sulfates, (C₆-C₁₈) alkoxylated phosphate esters, xylene sulfonate salts, cumene sulfonate salts, naphthalene sulfonates, alkyl naphthalene sulfonates, condensated alkyinaphahalene sulfonates, and combinations thereof. Nonionic surfactants include natural or synthetic alkoxylated alcohols, preferably ethoxylated and/or propoxylated alcohols, further preferably ethoxylated and/or propoxylated fatty alcohols or fatty acids, further preferably containing from 8 to 22 carbon atom; short ethoxylated and/or propoxylated chain alcohols, preferably short ethoxylated and/or propoxylated fatty alcohols; ethoxylated fatty acids; alkoxylated sorbitan fatty esters, ethoxylated sorbitan fatty esters; alkoxylated sorbitol fatty esters, ethoxylated sorbitol fatty esters, polyoxyethylene sorbitan monolaurate, polyoxyethylene sorbitan inonopalmitate, polyoxyethylene sorbitan monostearate; (C₆-C₂₂) alkoxylated fatty alcohols, (C₆-C₂₂) ethoxylated fatty alcohols, (C₆-C₂₂) propoxylated fatty alcohols, (C₆-C₂₂) ethoxylated and propoxylated fatty alcohols; alkyl(poly)glycosides, straight chain (C₄-C₁₀) alkyl(poly)glycosides, branched chain (C₄-C₁₀) alkyl(poly)glycosides; and combinations thereof.

The pH of the composition can be maintained by the use of a mixture of sodium citrate and citric acid. Other acid/salt mixtures can be employed. The farnesene formulation (in concentrated form) may have a pH range of between about 5.0 to about 10.0, and in diluted form can have a pH range of between 6.0 to about 8.0.

In a concentrated form, the farnesene, in a concentration of from about 0.01% by weight to 1% by weight, is diluted with an oil, e.g., vegetable oil, in a concentration of 10-90% by weight, with the remaining components including other agricultural chemicals or diluents.

The farnesene formulations may further comprise at least one compound selected from the group consisting of insecticides, fungicides, herbicides, desiccants, defoliants, acaricides, nutrients, miticides, bactericides, biocides, ovicides, nematicides, insect growth regulators, plant growth regulators, and combinations thereof.

The farnesene formulations may further comprise at least one additive selected from, but not limited to, the group consisting of nutrients, stimulants, growth agents, sugars, amino-acids, micronutrients (including fertilizers and hormones), preservatives, clarifiers, anti-freezing agents, hydrotropes, stabilizers, antioxidants, acidifiers, chelates, complexing agents, dyes, rheology modifiers, antifoams, anti-drift, water, oil(s), other solvents and combinations thereof.

The oil employed as a diluent may be a natural compound, or one modified by esterification or transesterification, such as an alkyl fatty acid ester, e.g., methyl esters, ethyl esters, propyl esters, butyl esters, 2-ethylhexyl esters or dodecyl esters, and is preferably a glycol or glycerol fatty acid, such as (C₁₀-C₂₂) fatty acid esters, such as from vegetables oils, preferably oil-yielding plants species such as soybean, corn, sunflower, rapeseed oil, cottonseed oil, linseed oil, palm oil, safflower, coconut oil, castor oil, olive Oil, canola oil among others pure or mixed with an essential or edible oil extracted from a variety of plants or parts of plants such as trees, shrubs, leaves, flowers, grasses, fluids, herbs, fruits and seeds, or mixed with each other that are combined with one or more oils.

Alternatively, or additionally, the oil may be a natural oil, a synthetic oil, a linear compound, a branched compound, a saturated oil, an unsaturated oil, an aliphatic compound, a cyclic compound, a modified oil, an unmodified oil, an alkylated vegetable oil, an essential oil, an edible oil, an oil extracted from a plant, an oil extracted from a part of a plant, an oil extracted from a tree, an oil extracted from a shrub, an oil extracted from a leaf, an oil extracted from a flower, an oil extracted from a grass, an oil extracted from a plant fluid, an oil extracted from an herb, an oil extracted from a fruit, an oil extracted from a seed, a pure oil, a mixture of oils and combinations thereof.

It is to be understood that the farnesene formulation in its concentrated form may further be diluted with water or other solvent chemistries prior to application thereof in use. Alternatively, the farnesene formulation may be provided in a form suitable for immediate use without dilution.

In use, the farnesene formulation (in concentrate form) may be diluted, wherein a resulting stable spray or tank mix of the diluted agricultural composition can be applied onto, or adjacent to, a plant or part thereof.

It is to be understood that the composition according this disclosure may be packaged and sold in a single container including the farnesene formulation in its concentrated form. In use, a user may dilute the composition prior to application to an agricultural crop.

Provided are agricultural compositions for use in the control of pathogens and/or in the treatment of disease caused by said pathogens.

Provided is a method of controlling and/or treating pathogens and/or a method of treating disease caused by said pathogens, the method comprising the steps of applying the agricultural composition as described herein above onto, or adjacent to, a plant or seed.

The composition can be diluted to provide the diluted agricultural composition, preferably diluted in water, before application onto, or adjacent to, a plant or seed or soil.

The application onto, or adjacent to, a plant or seed or soil, is via at least one apparatus selected from the group comprising of air assisted sprayers, conventional sprayers, ultra-low volumes equipment such as aerial, electrostatic, foggers and misting spray equipment and chemigation systems, pivots, sprinklers, and combinations thereof.

The application may be to pre-harvested or post--harvested plants selected from, but not limited to, the group comprising: plants, trees, fruits, vegetables, leaves, stems, roots, seeds, or flowers, animals, equipment, stockyards, feedlots, barns, animal housing units, farm tools, farm buildings, storage areas, soil, or food contact areas, such that in use fungal and/or bacterial pathogens that cause disease are controlled, e.g., powdery white mildew, or certain flies, mosquitos, aphids, thrips, ants, and other pests.

The agricultural composition, preferably the diluted agricultural composition, may be prepared in a mixing tank, a spray tank, a container, or an inline irrigation system prior to application and/or use.

Accordingly, in a first aspect (independently combinable with any other aspect or embodiment) an agricultural composition concentrate is provided, comprising: at least one sesquiterpene; and a carrier fluid.

In an embodiment of the first aspect (independently combinable with any other aspect or embodiment), the sesquiterpene is a farnesene.

In an embodiment of the first aspect (independently combinable with any other aspect or embodiment), the agricultural composition concentrate comprises from 0.001-1 wt. % of the farnesene.

In an embodiment of the first aspect (independently combinable with any other aspect or embodiment), the agricultural composition concentrate comprises from 0.01-0.1 wt. % of the farnesene.

In an embodiment of the first aspect (independently combinable with any other aspect or embodiment), the carrier fluid is an oil, optionally a vegetable oil, optionally soybean oil.

In an embodiment of the first aspect (independently combinable with any other aspect or embodiment), the agricultural composition concentrate comprises from 10-90 wt. % of the oil.

In an embodiment of the first aspect (independently combinable with any other aspect or embodiment), the agricultural composition concentrate comprises from 10-40 wt. % of the oil.

In an embodiment of the first aspect (independently combinable with any other aspect or embodiment), the agricultural composition concentrate further comprises a buffering agent, optionally citric acid and sodium citrate.

In an embodiment of the first aspect (independently combinable with any other aspect or embodiment), the agricultural composition concentrate further comprises a detergent and/or surfactant.

In an embodiment of the first aspect (independently combinable with any other aspect or embodiment), the detergent or surfactant is a nonionic surfactant is selected from the group consisting of natural or synthetic alkoxylated alcohols, preferably ethoxylated and/or propoxylated alcohols, further preferably ethoxylated and/or propoxylated fatty alcohols or fatty acids, further preferably containing from 8 to 22 carbon atom; short ethoxylated and/or propoxylated chain alcohols, preferably short ethoxylated and/or propoxylated fatty alcohols; ethoxylated fatty acids; alkoxylated sorbitan fatty esters, ethoxylated sorbitan fatty esters; alkoxylated sorbitol fatty esters, ethoxylated sorbitol fatty esters, polyoxyethylene sorbitan monolaurate, polyoxyethylene sorbitan monopalmitate, polyoxyethylene sorbitan monostearate; (C₈-C₂₂) alkoxylated fatty alcohols, (C₈-C₂₂) ethoxylated fatty alcohols, (C₈-C₂₂) propoxylated fatty alcohols, (C₈-C₂₂) ethoxylated and propoxylated fatty alcohols, alkyl(poly)glycosides, straight chain (C₄-C₁₀) alkyl(poly)glycosides, branched chain (C₄-C₁₀) alkyl(poly)glycosides; and combinations thereof.

In an embodiment of the first aspect (independently combinable with any other aspect or embodiment), the agricultural composition concentrate comprises from 5-40 wt. % of the detergent and/or surfactant.

In an embodiment of the first aspect (independently combinable with any other aspect or embodiment), the agricultural composition concentrate comprises from 10-20 wt. % of the detergent and/or surfactant.

In an embodiment of the first aspect (independently combinable with any other aspect or embodiment), the agricultural composition concentrate comprises from 5-40 wt. % of the detergent.

In an embodiment of the first aspect (independently combinable with any other aspect or embodiment), the agricultural composition concentrate comprises from 10-20 wt. % of the detergent.

In an embodiment of the first aspect (independently combinable with any other aspect or embodiment), the agricultural composition concentrate comprises from 5-40 wt. % of the surfactant.

In an embodiment of the first aspect (independently combinable with any other aspect or embodiment), the agricultural composition concentrate comprises from 10-20 wt. % of the surfactant.

In an embodiment of the first aspect (independently combinable with any other aspect or embodiment), the agricultural composition concentrate comprises 25% by weight soybean oil, 15% by weight sodium lauryl sulfate, and 0.02% by weight farnesene.

In an embodiment of the first aspect (independently combinable with any other aspect or embodiment), the agricultural composition concentrate further comprises sodium citrate and citric acid.

In an embodiment of the first aspect (independently combinable with any other aspect or embodiment), the agricultural composition concentrate further comprises sodium citrate and citric acid.

In an embodiment of the first aspect (independently combinable with any, other aspect or embodiment), the agricultural composition concentrate further comprises detergent.

In an embodiment of the first aspect (independently combinable with any other aspect or embodiment), the agricultural composition concentrate further comprises water.

In an embodiment of the first aspect (independently combinable with any other aspect or embodiment), the agricultural composition concentrate further comprises ethanol.

In an embodiment of the first aspect (independently combinable with any other aspect or embodiment), the agricultural composition concentrate further comprises at least one additive selected from the group consisting of nutrients, stimulants, growth agents, sugars, amino-acids, micronutrients (including fertilizers and hormones), preservatives, clarifiers, anti-freezing agents, hydrotropes, stabilizers, antioxidants, acidifiers, chelates, complexing agents, dyes, rheology modifiers, antifoams, anti-drift, water, oil(s), other solvents and combinations thereof.

In a second aspect (independently combinable with any other aspect or embodiment), the agricultural composition concentrate of the first aspect is for use in the control of an agricultural pathogen and/or in the treatment of disease caused by the agricultural pathogen.

In an embodiment of the second aspect (independently combinable with any other aspect or embodiment), the pathogen is white powdery mildew.

In an embodiment of the second aspect (independently combinable with any other aspect or embodiment), the pathogen is selected from the group consisting of leaf aphids, thrips, white flies, russet mites, spider mites, and broad mites.

In an embodiment of the second aspect (independently combinable with any other aspect or embodiment), the pathogen is selected from the group consisting of flies, aphids, mosquitos, and ants.

In a third aspect (independently combinable with any other aspect or embodiment), a diluted agricultural composition is provided, comprising the concentrate of the first aspect diluted in water.

In a fourth aspect, (independently combinable with any other aspect or embodiment), a method of controlling and/or treating agricultural pathogens and/or a method of treating disease caused by said agricultural pathogens is provided, the method comprising applying the diluted agricultural composition of claim 28 onto, or adjacent to pre-harvested or post-harvested trees, plants, fruits, flowers, roots, or seeds.

In an embodiment of the fourth aspect (independently combinable with any other aspect or embodiment), the application onto, or adjacent to a tree, a plant, fruits, flowers, roots or seed, is via an apparatus selected from the group consisting of air assisted sprayers, conventional sprayers, ultra-low volumes equipment such as aerial, electrostatic, foggers and misting spray equipment and chemigation systems, pivots, sprinklers, and combinations thereof.

In an embodiment of the fourth aspect (independently combinable with any other aspect or embodiment), the application is onto Cannabis sativa plants.

### DETAILED DESCRIPTION

The compositions of the various embodiments were precisely developed to prevent and control pest in powdery mildew in commercial and home gardens. The compositions of the various embodiments use an ecofriendly blend of nontoxic ingredients as well as an exclusive bug block technology. The compositions of the various embodiments comprise a blend of sesquiterpenes that is one of nature's most powerful pest repellents and found in many natural sources.

The compositions of the various embodiments are EPA registration exempt as a low risk pesticide and QR Code enabled linked to pesticide lab analysis to ensure consumers that the compositions of the various embodiments are pesticide free.

The compositions of the various embodiments are a breakthrough product developed under Project Hemp for Victory, which is operated by Hempyre Genetics of Oklahoma City, OK, the general contractor for Northwestern Oklahoma State University's industrial hemp pilot program. The program is the world's first advanced research project to acquire multiple varieties of Cannabis growing across the state of Oklahoma for research. Hempyre Genetics acquired over 100 varieties of industrial hemp growing wild and began growing each in a closed environment immediately. Upon planting multiple of the selected varieties of landrace Cannabis, it was noted that the different cultivars had various traits.

Selected varietals went through numerous tests for stress factors such as heat, cold, deprivation of nutrients, high and low humidity, root bounding, light deprivation and sensitivity changes. Signs of pests and other problems such as powdery white mildew were immediately observed. Regulations and restrictions set forth by the Oklahoma Department of Agriculture made it very difficult to combat these problems without the use of traditional pesticides and mildew control products.

It was observed that one specific variety of hemp from a remote location in Oklahoma was virtually unaffected by many of these problems that were becoming detrimental to all of the other cultivars. Upon the completion of the grow cycle and harvesting the mature plants, samples were sent off for analysis. This unique strain of hemp found in the wild on the plains of Oklahoma contained a unique terpene complex of six sesquiterpenes, commonly referred to as farnesene.

The term farnesene refers to a set of six closely related chemical compounds which all are sesquiterpenes. α-Farnesene and β-farnesene are isomers, differing by the location of one double bond α-Farnesene is 3,7,11-trimethyl-1,3,6,10-dodecatetraene and β-farnesene is 7,11-dimethyl-3-methylene-1,6,10-dodecatriene. The alpha form can exist as four stereoisomers that differ about the geometry of two of its three internal double bonds (the stereoisomers of the third internal double bond are identical). The beta isomer exists as two stereoisomers about the geometry of its central double bond. Two of the α-farnesene stereoisomers are reported to occur in nature. (E,E)-α-Farnesene is the most common isomer. It is found in the coating of apples, and other fruits, and it is responsible for the characteristic green apple odor. Its oxidation by air forms compounds that are damaging to the fruit. The oxidation products injure cell membranes which eventually causes cell death in the outermost cell layers of the fruit, resulting in a storage disorder known as scald. (Z,E)-α-Farnesene has been isolated from the oil of perilla. Both isomers are also insect semiochemicals they act as alarm pheromones in termites or food attractants for the apple tree pest, the codling moth. α-Farnesene is also the chief compound contributing to the scent of gardenia, making up ˜65% of the headspace constituents. β-Farnesene has one naturally occurring isomer. The E isomer is a constituent of various essential oils. It is also released by aphids as an alarm pheromone upon death to warn away other aphids. Several plants, including potato species, have been shown. to synthesize this pheromone as a natural insect repellent. The farnesene can act as a fungicide, bactericide, insecticide, pesticide or a combination thereof. The farnesene may be a fungicide, e.g., that is effective against powdery white mildew. The farnesene can be a pesticide, e.g., that is effective against flies, aphids, mosquitos, and ants.

After attempting to utilize over 40 different methodologies, an ecofriendly product was developed containing an ecofriendly blend of ingredients along with the same ratio of farnesene components observed in the hemp observed earlier to be resistant to pests. Not only was a turnaround in the number of pests observed after treatment, but also a complete eradication of powdery white mildew. Powdery white mildew is a very common problem to indoor gardens around the world, especially in regions of high humidity. It was observed that the plant responded positively to application of the composition after the first application, and within 24 hours drooping and yellowing in the leaves diminished, with the leaves beginning to reach upward and regain color. The varieties most affected by the powdery white mildew were 95% free of any visible mildew within 24 hours, and within 48 hours began regaining lost color and turning green where the mildew was affecting the leaf.

The compositions of the embodiments have numerous applications from small indoor gardens to agronomic scale farming, and are the next generation solution to the control and management of many problems currently faced by cultivators and farmers globally in every field. The ecological impact in reduction of the need to use modern pesticides will improve environmental conditions. Hempyre Genetics has developed these formulations having specific Sesquiterpene percentages with B-Farnesene effective in BlueMagic™. Hempyre Genetics has developed BlueMagic™ as a new product category called Hempicide™. The special method and process applied are referred to as BlueGreenEarthScience™. Slogans for industry category identifier such as PlantsLoveIt™, PestHateIt™, AvoidTheTragic-UseBlueMagic™, Bug Block™, Bug Block Technology™, Eco Friendly Pesticide™ and Ecological Sustainability™ are used in conjunction with the special method and process.

Farnesene is labeled as non-toxic in Ecolabel Lubricant Substance Classification List. Farnesene-derived base oils have undergone extensive toxicity testing for many regulatory registrations (see below attached image), in all tests they were found to be as safe as white oils, which are known to have low toxicity. See, e.g., Table 26.5, reproduced below, from “Synthetics, Mineral Oils, and Bio-Based Lubricants: Chemistry and Technology”, Leslie R. Rudrick, CRC Press, Jan. 29, 2020.

TABLE 26.5
Regulatory Toxicity Testing of Farnesene-Derived Base Oil [34]

| Toxic [symbol] | | | Safety [symbol] |
|---|---|---|---|
| Properties | Test Method | Results | (SOS) Classification |
| [symbol] - [symbol] | [symbol] | [symbol] | [symbol] |
| [symbol] - [symbol] | [symbol] | [symbol] | [symbol] |
| [symbol] - [symbol] | [symbol] | [symbol] > [symbol] mg/L | [symbol] |
| [symbol] | [symbol] | [symbol] | [symbol] |
| [symbol] | [symbol] | [symbol] | [symbol] |
| [symbol] | — | — | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | — | — | [symbol] |
| [symbol] | [symbol] | [symbol] | [symbol] |
| [symbol] | [symbol] | [symbol] | [symbol] |
| [symbol] | | | |
| [symbol] | [symbol] | [symbol] | [symbol] |

[symbol]

indicates data missing or illegible when filed

Farnesene-derived oils have also undergone extensive ecotoxicity testing and found to be non-toxic in key environmental areas (see excerpt below from “Synthetics, Mineral Oils, and Bio-Based Lubricants: Chemistry and Technology”, Leslie R. Rudrick, CRC Press, Jan. 29, 2020).

Results - [symbol] Effect

| [symbol] Properties | Test Method | [symbol] | [symbol] Classification |
|---|---|---|---|
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | | | |
| [symbol] | [symbol] | [symbol] | [symbol] |
| [symbol] | | | |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | |

[symbol]

indicates data missing or illegible when filed

Farnesene, mixture of isomers (https://www.scbt.com/p/farnesene-mixture-of-isomers-502-61-4?lang=en&cur=usd#CertificateAnalysis-collapse) has CAS No. 502-61-4, Molecular weight: 204,35, and Molecular Formula: C₁₅H_{24.} The formulations provided herein are suitable for use in the mitigation and/or prevention of one or more pathogens selected from the group consisting of powdery mildew, leaf aphids, thrips, white flies, russet mites, spider mites, and broad mites.

### Rate and Timing of Application

The formulation is typically provided as a concentrate which is diluted with a suitable diluent, e.g., water, then applied to an infestation or a plant. In one aspect, the concentration comprises an oil as a carrier, along with a surfactant and the sesquiterpene. For example, the concentrate can comprise a mixture of soybean oil 25% by weight, sodium lauryl sulfate 15% by weight, and farnesene 0.02% by weight, with the remainder of the formulation comprising other ingredients 60% by weight (e.g., sodium citrate, citric acid, water, detergent and alcohol) is provided. For regular use or maintenance 1 ounce of the concentrate can be mixed with 1 gallon of water. For treatment of an infestation, 2 ounces of the concentrate can be mixed with 1 gallon of water.

In a typical application, e.g., to a Cannabis sativa or Cannabis indica plant, it is recommended not to apply to plants under a grow light when powered on. Typically, the concentrate is diluted in water, and can be advantageously mixed in a spray bottle by shaking. The plant is sprayed with the diluted concentrate so as to spray the entire plant thoroughly, covering all leaves, stems, and stalk, The plan is allowed to dry before turning grow lights on, as exposure to strong light while wet may cause damage to plants.

The production and use of an agricultural composition for application to plants, such as Cannabis sativa, including a sesquiterpene mixture, namely, a type of farnesene, are provided. Typically, the farnesene formulation is manufactured as a concentrate which is then admixed to provide the agricultural composition. The farnesene formulation may be diluted prior to admixture. Alternatively, the farnesene formulation may be admixed and diluted thereafter. The agricultural composition is typically diluted with water providing a stable spray or tank mix form of diluted agricultural composition prior to use and application onto, or adjacent to, agricultural crops to control pathogen populations and/or control and/or treat disease related to the pathogens, particularly powdery white mildew, e.g., in nursery stock, Cannabis plants, and table and wine grapes. The disclosure extends to application of the agricultural composition to, or adjacent to, soil, buildings, equipment and the like. The agricultural composition according to this disclosure is stable prior to and when in use.

The farnesene is typically provided in admixture with an oil, such as a vegetable oil, e.g., soybean oil. A typical concentrate comprises from 0.005% by weight to 1% by weight of the farnesene, from 10-90% of the oil, with the remainder other ingredients as are typically employed in agricultural compositions. These can include diluents (water, ethanol), buffering agents (sodium citrate and citric acid), and a detergent/surfactant. The farnesene formulation is suitable for dilution in water and is stable as both a concentrate and as a spray or tank mix.

### Definitions

The term “stable” as used herein is a broad term, combined or related with the term “emulsion”, and is to be given its ordinary and customary meaning to a person of ordinary skill in the art (and is not to be limited to a special or customized meaning), and refers without limitation to the emulsion stability, i.e. the ability of an emulsion to resist change in its properties over tune so that the size of the droplets in emulsion does not change significantly with time, more specifically during the time of an application to the targets mixed with water, it is thus to be given its ordinary meaning that is customary to a person skilled in the art. The term “stable” as used herein is a broad term, combined or related with the term “accelerated storage stability”, means that the formulation keep similar performance in terms of physico-chemical properties after samples be stored during 15 days in at least 3 conditions: room temperature (around 20° C.); cold temperature (0° C. or 5° C.); hot temperature (54° C.). Storage stability tests were conducted according Method CIPAC MT 36.

The term “solvents” as used herein is a broad term, and is to be given its ordinary and customary meaning to a person of ordinary skill in the art (and is not to be limited to a special or customized meaning), and refers without limitation to compounds with some characteristics of solvency for other compounds or means, that can be polar or non-polar, linear or branched, cyclic or aliphatic, aromatic, naphthenic and that includes but is no limited to: alcohols, esters, diesters, ketones, acetates, terpenes, sulfoxides, glycols, paraffins, hydrocarbons, anhydrides, heterocyclics, among others.

The term “alcohol” as used herein is a broad term, and is to be given its ordinary and customary meaning to a person of ordinary skill in the art (and is not to be limited to a special or customized meaning), and refers without limitation to any compound as described herein incorporating one or more hydroxy groups, or being substituted by or functionalized to include one or more hydroxy groups.

The term “terpenes” as used herein is a broad term, and is to be given its ordinary and customary meaning to a person of ordinary skill in the art (and is not to be limited to a special or customized meaning), and refers without limitation to any compound as derived from resins of plants such as conifers, or to synthetically produced compounds having the same structures as plant derived terpenes. Terpenes can include hydrocarbons as well as terpenoids containing additional functional groups, as well as essential oils. Terpenes can include compounds having a formula (C₅H₈) where n is the number of linked isoprene units (e.g., 1, 2, 3, 4, 5, 6, 7, 8, 9, 10, or more). Terpenes also include sesquiterpenes, such as the six component sesquiterpene mixture known as farnesene.

The term “vegetable oil” as used herein is a broad term, and is to be given its ordinary and customary meaning to a person of ordinary skill in the art (and is not to be limited to a special or customized meaning), and refers without limitation to oleaginous fatty acid constituents of vegetable matter, e.g., saturated fatty acids, monounsaturated fatty acids, polyunsaturated fatty acids, etc. The vegetable oil can be functionalized, e.g., alkoxylated, hydroxylated, aminated, etc. A functionalized vegetable oil is a derivative of a vegetable oil or other fatty substance, or a substance having a similar composition regardless of the origin of the substance. In some embodiments, the functionalized vegetable oil is epoxidized unsaturated triglyceride. Epoxidized unsaturated triglyceride is a tri-ester of glycerin. The glycerin bonds to three linear or branched carboxylic acids, wherein at least one of the carboxylic acids comprises an epoxide moiety. For example, the epoxidized unsaturated triglyceride may be a derivative of an unsaturated fatty acid triglyceride such as a vegetable or animal fat or oil, wherein at least one of the C═C moieties of the parent unsaturated fatty acid triglyceride is replaced with an epoxide moiety (i.e. a three-membered ring containing an oxygen). If the parent unsaturated fatty acid triglyceride has more than one C═C moiety, one, part, or all of the C═C moieties may be replaced by epoxide moieties. When the term “vegetable oil” is used herein, it is understood to include animal fats, or oils of synthetic origin, having a same chemical structure as a vegetable oil. Examples of vegetable or animal fats or oils include coconut oil, corn oil, cottonseed oil, olive oil, palm oil, peanut oil, rapeseed oil, canola oil, safflower oil, sesame oil, soybean oil, sunflower oil, castor oil, tallow oil, or the like.

As used herein, the abbreviations for any compound, is, unless indicated otherwise, in accord with its common usage, recognized abbreviations, or the IUPAC-TUB Commission on Biochemical Nomenclature (See, Biochem. 11:942-944 (1972)).

Any percentages, ratios or other quantities referred to herein are on a weight basis, unless otherwise indicated.

Unless otherwise defined, all terms (including technical and scientific terms) are to be given their ordinary and customary meaning to a person of ordinary skill in the art, and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation, ’ ‘including but not limited to, ’ or the like; the term ‘comprising’ as used herein is synonymous with ‘including, ’ ‘containing, ’ or ‘characterized by, ’ and is inclusive or open-ended and does not exclude additional, unrecited elements or method steps; the term ‘having’ should be interpreted as ‘having at least; ’ the term ‘includes’ should be interpreted as ‘includes but is not limited to; ’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably, ’ ‘preferred, ’ ‘desired, ’ or ‘desirable, ’ and words of similar meaning should not be understood as implying that certain features are critical, essential, or even important to the structure or function of the invention, but instead as merely intended to highlight alternative or additional features that may or may not be utilized in a particular embodiment of the invention. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

There a range of values is provided, it is understood that the upper and lower limit, and each intervening value between the upper and lower limit of the range is encompassed within the embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations, ” without other modifiers, typically means at least two recitations, or two or more recitations). Furthermore, in those instances where a convention analogous to “at least one of A, B, and C, etc. ” is used, in general such a construction is intended in the sense one having skill in the art would understand the convention (e.g., “a system having at least one of A, B, and C” would include but not he limited to systems that have A alone, B alone, C alone, A and B together, A and C together, B and C together, and/or A, B, and C together, etc.). In those instances where a convention analogous to “at least one of A, B, or C, etc. ” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B. ”

All numbers expressing quantities of ingredients, reagents, reaction conditions, and so forth used in the specification are to be understood as being modified in all instances by the term ‘about. ’ Accordingly, unless indicated to the contrary, the numerical parameters set forth herein are approximations that may vary depending upon the desired. properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

The agricultural composition according to this disclosure provides for an environmentally friendly, stable, and effective farnesene formulation for pathogen control, e.g., white powdery mildew. The agricultural composition allows easy dosage and easy use. Further, the composition allows for use, alone or in combination with other agricultural treatment protocols in pre-harvest or post-harvest plant crops, seeds, flowers, fruits, vegetables, trees, animals, equipment, cleaning tools, greenhouses, soils, and other spaces on the farm or industrial facilities.

Furthermore, although the foregoing has been described in some detail by way of illustrations and examples for purposes of clarity and understanding, it is apparent to those skilled in the art that certain changes and modifications may be practiced. Therefore, the description and examples should not be construed as limiting the scope of the invention to the specific embodiments and examples described herein, but rather to also cover all modification and alternatives coming with the true scope and spirit of the invention.

What is claimed is:

1. An agricultural composition concentrate comprising:
at least one sesquiterpene, and
a carrier fluid.

2. The agricultural composition concentrate of claim 1, wherein the sesquiterpene is a farnesene.

3. The agricultural composition concentrate of claim 2, comprising from 0.001-1 wt. % of the farnesene.

4. The agricultural composition concentrate of claim 2, comprising from 0.01-0.1 wt. % of the farnesene.

5. The agricultural composition concentrate of claim 1, wherein the carrier fluid is an oil, optionally a vegetable oil, optionally soybean oil.

6. The agricultural composition concentrate of claim 5, comprising from 10-90 wt. % of the oil.

7. The agricultural composition concentrate of claim 5, comprising from 10-40 wt. % of the oil,

8. The agricultural composition concentrate of claim 1, further comprising a buffering agent, optionally citric acid and sodium citrate.

9. The agricultural composition concentrate of claim 1, further comprising a detergent and/or surfactant.

10. The agricultural composition concentrate of claim 9, wherein the detergent or surfactant is a nonionic surfactant is selected from the group consisting of natural or synthetic alkoxylated alcohols, preferably ethoxylated and/or propoxylated alcohols, further preferably ethoxylated and/or propoxylated fatty alcohols or fatty acids, further preferably containing from 8 to 22 carbon atom; short ethoxylated and/or propoxylated chain alcohols, preferably short ethoxylated and/or propoxylated fatty alcohols; ethoxylated fatty acids; alkoxylated sorbitan fatty esters, ethoxylated sorbitan fatty esters; alkoxylated sorbitol fatty esters, ethoxylated sorbitol fatty esters, polyoxyethylene sorbitan monolaurate, polyoxyethylene sorbitan monopalmitate, polyoxyethylene sorbitan monostearate; (C₈-C₂₂) alkoxylated fatty alcohols, (C₈-C₂₂) ethoxylated fatty alcohols, (C₈-C₂₂) propoxylated fatty alcohols, (C₈-C₂₂) ethoxylated and propoxylated fatty alcohols, alkyl(poly)glycosides, straight chain (C₄-C₁₀) alkyl(poly)glycosides, branched chain (C₄-C₁₀) alkyl(poly)glycosides; and combinations thereof.

11. The agricultural composition concentrate of claim 9, comprising from 5-40 wt. % of the detergent and/or surfactant.

12. The agricultural composition concentrate of claim 9, comprising from 10-20 wt. % of the detergent and/or surfactant.

13. The agricultural composition concentrate of claim 9. comprising from 5-40 wt. % of the detergent.

14. The agricultural composition concentrate of claim 9, comprising from 10-20 wt. % of the detergent.

15. The agricultural composition concentrate of claim 9, comprising from 5-40 wt. % of the surfactant.

16. The agricultural composition concentrate of claim 9, comprising from 10-20 wt. % of the surfactant.

17. The agricultural composition concentrate of claim 1, comprising 25% by weight soybean oil, 15% by weight sodium lauryl sulfate, and 0.02% by weight farnesene.

18. The agricultural composition concentrate of claim 17, further comprising sodium citrate and citric acid.

19. The agricultural composition concentrate of claim 18, further comprising sodium citrate and citric acid.

20. The agricultural composition concentrate of claim 19, further comprising detergent.

21. The agricultural composition concentrate of claim 20, further comprising water.

22. The agricultural composition concentrate of claim 20, further comprising ethanol.

23. The agricultural composition concentrate of claim 1, further comprising at least one additive selected from the group consisting of nutrients, stimulants, growth agents, sugars, amino-acids, micronutrients (including fertilizers and hormones), preservatives, clarifiers, anti-freezing agents, hydrotropes, stabilizers, antioxidants, acidifiers, chelates. complexing agents, dyes, rheology modifiers, antifoams, anti-drift, water, oil(s), other solvents and combinations thereof.

24. The agricultural composition concentrate of claim 1 for use in the control of an agricultural pathogen and/or in the treatment of disease caused by the agricultural pathogen.

25. The agricultural composition concentrate of claim 24, wherein the pathogen is white powdery mildew.

26. The agricultural composition concentrate of claim 24, wherein the pathogen is selected from the group consisting of leaf aphids, thrips, white flies, russet mites, spider mites, and broad mites.

27. The agricultural composition concentrate of claim 24, wherein the pathogen is selected from the group consisting of flies, aphids, mosquitos, and ants.

28. A diluted agricultural composition, comprising the concentrate of claim I diluted in water.

29. A method of controlling and/or treating agricultural pathogens and/or a method of treating disease caused by said agricultural pathogens, the method comprising applying the diluted agricultural composition of claim 28 onto, or adjacent to pre-harvested or post-harvested trees, plants, fruits, flowers, roots, or seeds.

30. The method of claim 29, wherein the application onto, or adjacent to a tree, a plant, fruits, flowers, roots or seed, is via an apparatus selected from the group consisting of air assisted sprayers, conventional sprayers, ultra-low volumes equipment such as aerial, electrostatic, foggers and misting spray equipment and chemigation systems, pivots, sprinklers, and combinations thereof.

31. The method of claim 29, wherein the application is onto Cannabis sativa plants.
